(19) United States
(12) Patent Application Publication
(10) Pub. No.: US 2023/0138622 A1
(43) Pub. Date: May 4, 2023

(54) Emergency Access Control for Cross-Platform Computing Environment

(71) Applicant: Acxiom LLC, Conway, AR (US)

(72) Inventors: Larry A. Strezo, JR., Elmhurst, IL (US); Vineet Kumar Saini, Conway, AR (US); James Watkins, Conway, AR (US); Phillip Langley, Austin, TX (US)

(21) Appl. No.: 17/431,577

(22) PCT Filed: May 6, 2021
(86) PCT No.: PCT/US2021/031087

§ 371 Date: Aug. 17, 2021

Related U.S. Application Data
(60) Provisional application No. 63/022,778, filed on May 11, 2020.

(51) Int. Cl. H04L 9/32; H04L 9/12

(52) U.S. Cl. CPC H04L 9/3228; H04L 9/12

(57) ABSTRACT

A system and method for providing emergency access control for a unified data platform allowing a user to request access to a segregated data set of the unified data platform where the user can automatically be granted the minimum required access permission, therefore providing the user limited access only to the necessary data required for maintenance purposes, and where the access permission is based off authorization information associated with the user for various segregated data sets and associated parameters.

### CROSS REFERENCE TO RELATED APPLICATIONS

This application claims the benefit of U.S. Provisional Pat. Application No. 63/022,778, entitled “Emergency Access Control for Cross-Platform Computing Environment” and filed on May 11, 2020. Such application is incorporated herein by reference in its entirety.

### BACKGROUND OF THE INVENTION

Today’s availability of high-speed, high-capacity electronic communications networks (including the Internet), low-cost commodity-type computer servers and storage devices, the widespread adoption of hardware virtualization such as in computer clusters, service-oriented hardware and software architecture, and autonomic and utility computing has led to enormous growth in cloud computing. Cloud computing is the on-demand availability of computer system resources, especially data storage and computing power, without direct active management by the user of the computing resources. The term is generally used to describe data centers available to many users over the Internet, although the cloud may be public clouds that numerous parties use, private clouds allocated to a single user, or a hybrid cloud approach. Large clouds, predominant today, often have functions distributed over multiple locations from central servers. Cloud computing relies on sharing of resources to achieve coherence and economies of scale. Cloud computing also may relieve the user of the need for a deep knowledge and or expertise about the individual hardware and software components of the cloud, freeing the user to benefit from the technologies and concentrate on building and utilizing applications specific to its business model. This allows the user, such as a marketing services provider, to curtail its costs by eliminating the need for it to purchase, build out, and maintain its own compute infrastructure. Instead, the marketing services provider needs only to have a front-end system in order to access the data and/or applications that are executing in the cloud, and thus “virtualize” the compute environment for itself. In some applications, the user may need nothing more than a web browser in order to take advantage of cloud computing resources. Virtualization software separates the user from concern about individual physical computing devices to concentrate on the use of virtual devices, which may be a portion of a single physical device or may be implemented as many separate physical devices operating together, whether in close physical proximity or located far apart and connected by high-speed electronic networks. In the most extreme cases this may lead to a “serverless” computing model, in which the cloud computing provider fully manages starting and stopping virtual machines as necessary in order to serve user requests, and both physical and virtual machines are transparent to the end user.

Advocates of public and hybrid clouds note that cloud computing allows companies to avoid or minimize up-front compute infrastructure costs. Proponents also claim that cloud computing allows enterprises to get their applications up and running faster, with improved manageability and less maintenance, and that it enables information technology infrastructure teams to more rapidly adjust resources to meet fluctuating and unpredictable demand. In this model, the marketing service provider manages a very large database or datastore that stores the data records for up to an unlimited number of individual clients, each of whom may provide vast amounts of data to the marketing services provider. Another advantage of cloud computing is the potential for enhanced reliability, as the actual physical components of the system may be located at multiple redundant sites, providing improved business continuity and disaster recovery. The provider of the cloud computing resources may concentrate its technical expertise in these areas, whereas the user may concentrate its expertise on use of the data and applications placed in the cloud.

As concerns about privacy increase and the monetary value of data continues to grow, the ability to protect client data is of utmost importance when clients choose to develop business relationships with marketing service providers. Cloud storage presents particular issues and problems with respect to the protection of client data. Cloud computing poses privacy concerns because the service provider can theoretically access the data that is in the cloud at any time, because it is the cloud computing provider, not the marketing services provider or other user, who physically houses and maintains the computing hardware providing the cloud computing capability. The cloud provider could accidentally or deliberately alter or delete information. Many cloud providers can share or are required to share information with third parties under laws applicable in various jurisdictions. As one measure of protection, users can encrypt their data that is processed or stored within the cloud to prevent unauthorized access. Identity management systems can also provide practical solutions to privacy concerns in cloud computing. These systems distinguish between authorized and unauthorized users and determine the amount of data that is accessible to each entity. The systems work by creating and describing identities, recording activities, and deleting unused identities.

Marketing services providers must be extremely sensitive to the privacy of the data they maintain and process because this data includes personally identifiable information (PII). PII can include, for example, names, addresses, email addresses, and other information that can be used to identify a particular individual. There exists today a large patchwork of laws, regulations, and rules that govern the measures that a marketing services provider must employ in order to safeguard PII of the consumers about whom it maintains data. Significant legal frameworks include the General Data Protection Regulation (GDPR) applicable in the European Union (EU), and the California Consumer Privacy Act (CCPA) applicable to residents of the State of California. A marketing services provider must ensure that it adheres to these legal requirements, and must also consider the possibility of future legal requirements that may be implemented. Ethical marketing services providers will also adhere to best practices for the protection of PII as have been promulgated by various industry group and trade organizations. The many legal and extra-legal requirements applicable to marketing services providers, as entities that must safeguard PII, has greatly hampered the adoption of cloud computing within the industry due to the concerns about privacy of PII that is maintained in the cloud, and concerns about commingling of data from different clients. In addition, the fact that the physical location of servers is often unknown in a cloud computing environment is incompatible with certain requirements of the GDPR, which regulates, among other things, the geographic location where data concerning EU residents may be physically stored.

A marketing services provider may implement a unified data platform to activate the data it maintains for its clients. A unified data platform, as used herein, is an open, trusted data framework for creating an omnichannel view of customers and connecting the cloud-based ecosystem. In addition to the necessity to eliminate the risk of commingling separate clients’ data, it is typical that in some cases, a single client may have multiple lines of business that operate in different countries or regions. Because there may be different privacy laws and regulations in different regions or countries as noted earlier, it may also be necessary to separate and manage a single client’s data based on area or region where the data is collected. The abstraction that is generally an inherent advantage of cloud computing architectures thus creates an obstacle for the use of a cloud computing environment for the storage, management, and utilization of certain types of data.

Maintaining complex, cloud-based computing environments such as a unified data platform requires a significant number of technical personnel, each with expertise in certain areas of the computing environment. Because these complex systems may contain highly sensitive data as noted above, access to these computing environments must be strictly controlled. On the other hand, those persons who are required to access the computing environments in order to maintain them in working order must be able to quickly gain access to the portion of the system that such person is responsible for maintaining or updating. In particular, there must be a means for appropriate technical personnel to gain emergency access to areas of the computing environment when a failure or other problem occurs. Currently manual methods of controlling access take time, and thus slow down the efforts to deal with an emergency problem.

When maintenance personnel are given access to such large, complex computing environments, they generally are not granted full access across the environment. The access is typically restricted based on the needs of the person being granted access. For example, a person may be given log-in credentials that are limited to only a certain period of time. This type of limitation does reduce risk, but may still allow an unscrupulous person to gain access beyond that needed in order to perform his or her assigned tasks, and thereby place the privacy of the data stored in the computing environment at greater risk than is necessary. Furthermore, this type of limitation on access does not consider various privacy laws and regulations, which may come into play on a complex computing environment with data stored in different legal jurisdictions, such as data stored in the EU where the GDPR is applicable. What is needed then is an improved method of granting emergency log-in access credentials that simultaneously allows a person to perform needed tasks while minimizing the risk of loss of private data within the computing environment and also is technically implemented in a manner that facilitates compliance with applicable privacy laws and regulations.

It would thus be desirable to develop an emergency log-in system in a cloud computing architecture that leverages the advantages of a cloud computing environment, but that overcomes the challenges of cloud computing environments including the concerns about privacy and commingling of data, and adherence to legal and extra-legal requirements concerning geographical situs and other aspects of data storage and use.

### SUMMARY OF THE INVENTION

Generally speaking, the present invention is directed to a system and method for providing emergency access control for a unified data platform, allowing a user to request emergency access and subsequently act automatically to grant the minimum required access permission using a privacy-controlled process that complies with applicable privacy laws, regulations, and rules. In various embodiments, the present invention may include processes to also provide monitoring and auditing of such emergency access. In certain embodiments, the invention automatically grants the least privileged permission level governed by tenant (i.e., client identifier), core (i.e., processing resource), and data groups, without violating data privacy rules. In these embodiments, access may also be limited to either identified or deidentified (i.e., anonymized) data only. The present invention is applicable, for example, in an architecture or platform that allows for the segregation of data/resources associated with multiple different clients or of data/resources associated with multiple business lines of a single client (or some combination thereof) in a cloud computing environment with specificity of geographical location of resources. The present invention enables the implementation of a unified data platform in a cloud environment, including cloud environments such as but not limited to Amazon Web Services (AWS), and integration with data processing platforms (such as Qubole) for resource management and analytics, which further can be extended to Google Cloud Platform (GCP), Microsoft Azure, and other cloud providers. The present invention allows the unified data platform to run in the cloud and allows for onboarding of unified data platform client data in, within the context of certain implementations of the invention, a matter of minutes as opposed to, for example, months. Certain implementations may include the automation of the setup/configuration process and provide the benefit of cloud services with an extended number of resources based on demand, all in a dynamic fashion. This approach makes the unified data platform a highly efficient and high performing “big data” platform. The architecture of the present invention thus allows for the advantages of cloud computing while also providing the necessary privacy protections inherent to such computing applications.

In certain implementations, the present invention allows for the management of client data from multiple individual clients without the improper commingling of such data. Furthermore, certain implementations allow for the segregation of a single client’s data based on region or line of business under the same client such that the client may remain in compliance with different privacy regulations of different regions, all still within a cloud computing environment in order to achieve the cost savings associated with this distributed computing approach.

### BRIEF DESCRIPTION OF THE SEVERAL VIEWS OF THE DRAWINGS

FIG. 1 is an overall system diagram for a unified data platform according to an implementation of the present invention.

FIG. 2 is a process flow diagram according to an implementation of the present invention.

### DETAILED DESCRIPTION

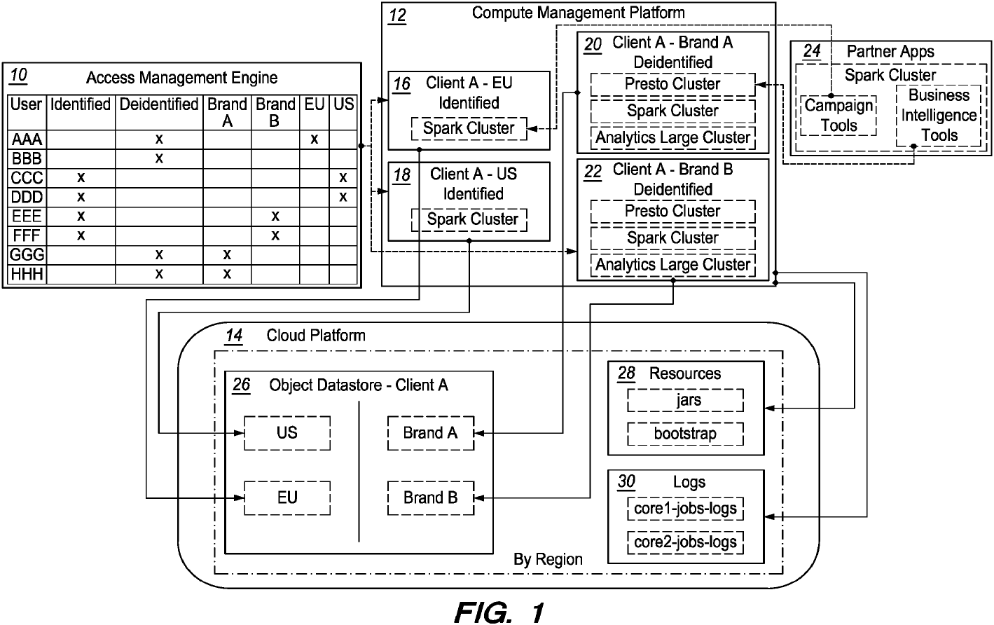

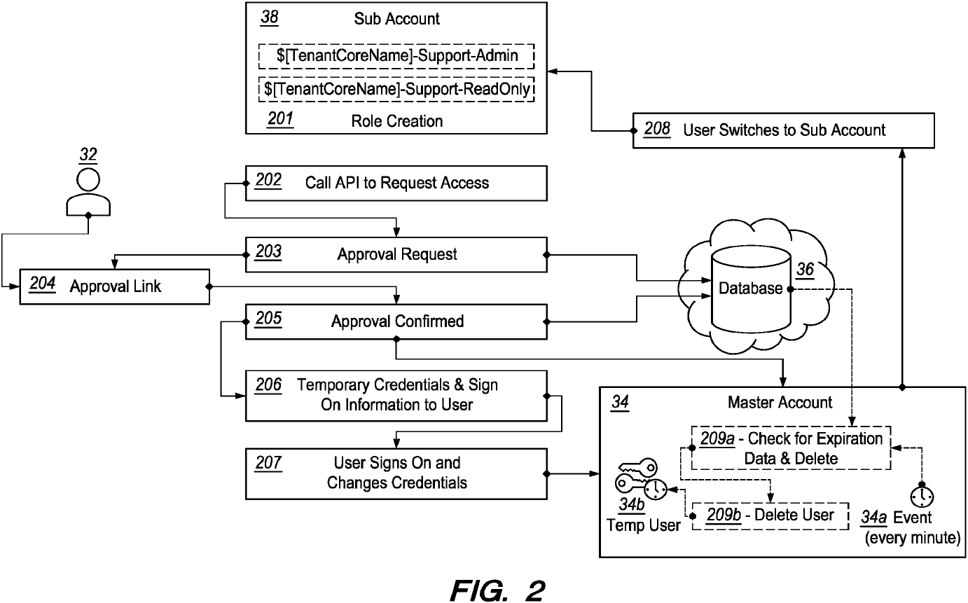

As noted above, the present invention is generally directed to a system and method for providing emergency access control for a unified data platform, allowing a user to request emergency access and subsequently act automatically to grant the minimum required access permission to the user, thereby providing the user limited access only to necessary data required for maintenance purposes. To accomplish this goal, the unified data platform is implemented to segregate client data into a number of data cores and user access is limited only to such data cores corresponding to that user’s authorization. An example of the data segregation and authorized access management architecture is shown in FIG. 1, while FIG. 2 shows one example of the authorization and emergency access control method of client data. It is understood, of course, that the invention is not so limited to these specific examples, but that the general architecture and access control method shown can be utilized in a cloud environment storing unlimited data records for many different clients.

For purposes of describing the invention, the term “client” may be used to describe the owner of one or more data records (and most likely millions of data records). Generally, the data records may contain information associated with one or more consumers. This information may include personally identifiable information (PII) about the consumers.

The term “data master” may refer to a person or entity (such as, for example, a marketing services provider) whose obligations including storing, managing, or processing the data of multiple clients. Thus, it may be seen that a data master has access to or otherwise controls a large amount of client data, portions of which belong to individual clients.

A “core” as used herein is a logically differentiated region of storage, which may be specific to a line of business for a client of a data master, which allows for the segregation of computing resources and data storage. In the preferred embodiment, a cloud core is a core allocated in cloud storage to provide dedicated resources for a core with 100% throughput utilizing per pay use and preferably scale on demand. And preferably, the cloud core allows for the segregation of computing resources and data storage by country or region. This creates an opportunity to support a unified data platform even in a country or region where a private data center operated by the data master does not exist.

A “data group” as used herein is a data grouping or category that may be based on various criteria, such as the type of data, the privacy rules for the data (identified or deidentified), or the like. It may be the basis for authorizing access to the associated data, and used to control who can access what data type, thereby serving to enforce applicable privacy laws, rules, and best practices.

As noted previously, for purposes of describing the unified data platform architecture of the present invention, one specific implementation of such unified data platform architecture may be understood with reference to FIG. 1. First, it may be seen that because the unified data platform architecture is useful for limiting user access to only authorized data, at access management routine 10, information is stored about the authorized users of the system and the various types of access each user is granted. Information regarding the authorization of users can be provided based on any number of parameters, which prevents unauthorized access to system data at a highly granular level. This is a privacy safeguard in the system, since each authorized user can only access data that the user has a need to access. This also facilitates management of data in the system that is geographically bifurcated. As further described below, user access may be defined based on, among other things, particular clients, particular brands for each client, identified or de-identified data, and geographic location of the data. For example, the access management routine 10 may include information that shows that User EEE is authorized to access identified data for Brand B.

Each data master user, once access is granted, accesses the system through compute management platform 12. Compute management platform 12 may be implemented as a single machine or multiple machines executing specially programmed software that provides a front-end to the portions of the system that are contained within cloud environment 14. Compute management platform 12 grants access to particular users according to the data provided from access management 10. Access may be granted, for example, according to the process outlined in FIG. 2, which is described more fully below. Once access is granted, given the unified data platform architecture, the user will only have limited access to authorized data, which has been segregated into cores.

For example, the unified data platform used in one implementation of the invention allows for the segregation of a single client’s data based on region or line of business under the same client such that the client may remain in compliance with different privacy regulations of different jurisdictions or regions. To accomplish these goals, the system utilizes unified data platform cloud cores for each of the different segregated data sets. The data/resources for different clients are segregated and the data/resources for different clients with multiple lines of business can be segregated as well. For example, consider the case of a client (Client A) who is a retailer with operations both in the United States and the European Union. If Client A has two separate lines of businesses as US-Brand A and EU-Brand A, each line of business may have identified and deidentified data type (categorized by privacy). Identified data is that data that contains personally identifiable information (PII), while deidentified data is that data where all PII has been removed. This deidentified data may also be known as anonymized data. As shown in FIG. 1, for example, Client A’s data may be segregated and handled with different cores and each core has a dedicated public cloud account (AWS for example). Thus, in this example, Client A- EU will be one core 16 and Client A - US will be a different core 18. The Client A -US core 18 is physically hosted in the US geographical region only, which means it gets a dedicated cloud service provider account in the U.S. region. This dedicated cloud account is used for this core 16 only for data storage and computing resources to process data.

Furthermore, all data in the cloud storage is tagged by type based on a privacy rule (for example, may be tagged as identified/deidentified). Any access to identified/deidentified data is managed through a separate dedicated account. These accounts may be managed by third-party platforms that facilitate management of large data sets in the cloud, such as provided by Qubole of Santa Clara, California. In this example, the US data is handled by a Qubole account in the US region only and based on privacy rules (such as identified/deidentified data) as applicable to this type of data. Access to data is managed through roles and policies. The Qubole platform may be used as an analytics application for the client to access core-specific data, with a number of dedicated accounts for which access is given to a subset of data as governed by the applicable identified or deidentified privacy rules. The Client A - EU core 16 is set up similarly except that it has a dedicated cloud account created and managed in the EU region, allowing the client to satisfy GDPR requirements concerning locality of data storage. Thus, the ability for each core 16, 18 to be managed by a dedicated account in the region corresponding to that client (or line of business) not only allows for compliance with region-specific regulations but also allows for privacy across multiple clients and/or multiple lines of business of a single client. With this framework, consider for example that a user may require read-only access to debug an issue in unified data platform production for a particular client for a specific core in the AWS us-east-1 region where user access should be restricted to deidentified (i.e., anonymized) data only. In accordance with certain implementations of the invention, this access must be temporary, approved appropriately, provided as quickly as possible, logged (i.e., archiving every event) to allow auditing and garbage collected (i.e., performing clean up) with minimal interaction.

Further, it may be seen that one or more partner applications 24 are granted access to certain data through compute management platform 12. For example, partner applications 24, such as campaign tools and business intelligence tools, may be granted access to specific client data, such as Client A- Brand A deidentified data 20, through compute management platform 12. This allows a single instantiation of each partner application to be used with respect to all data stored in the system. Any number of apps may be granted access through partner applications 24 in various implementations of the invention. Access to the data is controlled based on applications associated to a core (for example, a US core or an EU core) in cloud environment 14, and further may be based on privacy data groups, that is, identified data or deidentified data. Partner applications 24 may be implemented as a shared application instance, or could be a separate application installation per client/core or even a shared application with dedicated accounts.

Within cloud environment 14 (i.e., resources stored in the cloud) are object datastore 26, resources 28, and logs 30. Actual client data is stored in object datastore 26 in cloud environment 14 as one or more cores based on data groups. This data may be segregated based on client (Client A), client brand (Brand A and Brand B), identified or de-identified data, or data that is collected about consumers in different geographic regions (US vs EU). Cores that pertain to data from a particular geographic region are stored in that region, and thus it will be understood that cloud environment 14 may encompass physical storage sites distributed across any number of geographical regions. Access management 10, operating through compute management platform 12, controls access to the cores in object datastore 26 so that only authorized users for each core are allowed to access the data in the corresponding core.

In addition to the cores in object datastore 26, cloud environment 14 also includes shared resources. For example, per-region logs are maintained for each geographical region at logs 30. In addition, synched object datastores for resources are stored at resources 28. Resources 28 is a read-only resource synchronized across all regions through a shared account, and used by cores from storage in the corresponding region. In this case, resources 28 are used across all supported regions, and thus they are synched across all of these regions maintained by the system with corresponding object datastores in other regional areas of cloud environment 14.

Given the unified data platform architecture just described, the general process for providing user access to an authorized data core is illustrated in FIG. 2. It may be seen that this example is based on one specific example scenario, in which the unified data platform is implemented within AWS and a user needs support access to debug a failed job in production for a client for a specific core in a particular AWS region. First, at step 201, two support roles are created in the client sub account 38, one for admin access and the other for debugging. The roles may be created, for example, with the following standard naming convention: ${TenantCoreName}-support-admin and ${TenantCoreName}-support-readonly, as shown in FIG. 2, where ${TenantCoreName} is a unique string value for that client account. These roles will grant the ability of a Master Account 34 (an account where all client accounts are a member of its master organization, such as an AWS Organization) to assume such role. Access to the Master Account 34 is restricted so no unified data platform users can access it directly. Since the client account structure is organized into tenants and each tenant has at least one core, the security construct forces each tenant to have a list of “Approvers” that can be managed through the existing permission groups.

At step 202, a user submits a request for access via a call to the “Request” service. In the preferred embodiment, the access request must include the following information: (a) Tenant ID, (b) Type of access (Read Only or Administrative), (c) Requestor ID (d) Individual ID being granted the access, (e) Duration for access, and (f) Potentially other information, such as job ID and core ID. This request 202 will register the request event and all information about said request within a database 36 (such as Mongo Atlas, a non-SQL database) along with the date and time the request was made at step 203. This request will also trigger a message (for example, a message via Slack or Email) to a verified Approver 32 that contains a link for approval or denials (for example, an “Approval/Denial” RESTful API). The Approver 32 must authenticate using his or her own security credentials in order to approve the request at step 204. Once the request is approved at step 205, the “Approval” RESTful API will register the approval event within the database 36 including the Approver 32 and the date and time the approval was given. Based on the access request, the system will apply a set of rules to identify the environment (i.e., resolve which environment accesses need to be approved, like Development/Test/Production); and resources (i.e., identify what resources need access for that particular request). An example follows:
i. cloud platform resources
   1. AWS account
   2. Compute, storage, etc. resources
   3. Storage (S3) bucket
ii. applications
   1. resource management (e.g., Qubole, a compute resource management account which execute job and provide log access)
   2. business intelligence (BI) tools (e.g., Tableau)
   3. campaign management tools (e.g., IBM Campaign)
iii. tenant:
   1. identify tenant role

In addition to environment and resources, the access level must also be resolved, which includes tenant role, AWS access policies, and application access groups. Also, a set of rules are applied to verify that data privacy laws are not violated as defined by data groups. The approval confirmation at step 205 will prompt for the creation of a temporary user 34b on the Master Account 34 (with a timed policy).

Then, in order to grant access, temporary credentials and sign on information for the temporary user is generated at step 206 and transmitted to the user (via an email, for example). For example, the temporary credentials and sign on information may include a new AWS Identity and Access Management (IAM) user with a set of single use AWS console credentials. This temporary user 34b is granted only one permission: the ability to assume the role created for the tenant for which the request was generated. Once the temporary user 34b signs on and changes credentials at step 207, the user switches to the role on the client sub account 38. In one embodiment, the role information will be acquired based on the tenant ID provided in the approval request at step 202. This temporary user 34b will have its access management policy defined in such a way that it will only allow the user to assume the role for a predetermined amount of time, in one example not to exceed two days. This last policy condition will ensure that if any of the remaining steps used for revoking the access fails, the user will still have his or her access blocked based on the current date/time falling beyond the expiration date/time. In alternative embodiments, any other timeframe may be used.

In one embodiment, at step 206 an email will be sent to the user the access was granted for providing the temporary credentials and sign on information. Since the user had to be registered, his or her email is on file and will be looked up. The email will contain a link to the AWS console, single use credentials, instructions on how to change his or her password upon first use (using current restrictive password policies), instructions on how to switch between the Master Account 34 where the new user ID resides (but has no access), and the account number for which the request was made. For tracking and audit purposes, all information about the creation of the temporary access management user will be documented within the database 36 (e.g. MongoDB Atlas) including the created date and time, along with the expiration date and time.

Lastly, in the preferred embodiment there is an expiration function (such as an AWS Lambda function) running on the Master Account 34 periodically (configurable down to the minute 34a in one embodiment) for any requests that have been approved and whose expiration time is now past the current time (step 209a). At step 209b, temporary user 34b previously created is removed and all information regarding the removal of the user is recorded within the database 36. As noted, this ensures that if any of the remaining steps used for revoking the access fails, the user will still have his or her access blocked based on the current date/time falling beyond the expiration date/time.

It may be seen, then, that for this particular example, the components of the solution are: a section of cloud formation template that is run for each client account that defines the aforementioned role; a RESTful API that has a method for creating the aforementioned request; a RESTful API that has a method for creating the aforementioned approval; the aforementioned Lambda Function that scans the MongoDB Atlas datastore for requests that have expired in order to clean up; and an AWS cloud formation template that defines the aforementioned AWS Lambda function so that it can be deployed programmatically to the various environments (development, test, and production). The components are summarized in Table 1 below:

TABLE 1

| | | |
|---|---|---|
| Cloud Formation Template Name | Type of Component Created | Description of Component |
| aws-lz-client-analytics.template.yaml | AWS::IAM::Role | Role with Admin privileges that allows master account to assume it. |
| | AWS::IAM::Role | Role with ReadOnly privileges that allows master account to assume it. |
| aws-lz-Master.template-run2nd.yaml | AWS::Lambda::Function | Polls for users that have passed their expiration date and deletes them |
| | AWS::IAM::ManagedPolicy | Policy to allow Lambda access to necessary objects |

The systems and methods described herein may in various embodiments be implemented by any combination of hardware and software. For example, in one embodiment, the systems and methods may be implemented by a computer system or a collection of computer systems, each of which includes one or more processors executing program instructions stored on a computer-readable storage medium coupled to the processors. The program instructions may implement the functionality described herein. The various systems and displays as illustrated in the figures and described herein represent example implementations. The order of any method may be changed, and various elements may be added, modified, or omitted.

A computing system or computing device as described herein may implement a hardware portion of a cloud computing system or non-cloud computing system, as forming parts of the various implementations of the present invention. The computer system may be any of various types of devices, including, but not limited to, a commodity server, personal computer system, desktop computer, laptop or notebook computer, mainframe computer system, handheld computer, workstation, network computer, a consumer device, application server, storage device, telephone, mobile telephone, or in general any type of computing node, compute node, compute device, and/or computing device. The computing system includes one or more processors (any of which may include multiple processing cores, which may be single or multi-threaded) coupled to a system memory via an input/output (I/O) interface. The computer system further may include a network interface coupled to the I/O interface.

In various embodiments, the computer system may be a single processor system including one processor, or a multiprocessor system including multiple processors. The processors may be any suitable processors capable of executing computing instructions. For example, in various embodiments, they may be general-purpose or embedded processors implementing any of a variety of instruction set architectures. In multiprocessor systems, each of the processors may commonly, but not necessarily, implement the same instruction set. The computer system also includes one or more network communication devices (e.g., a network interface) for communicating with other systems and/or components over a communications network, such as a local area network, wide area network, or the Internet. For example, a client application executing on the computing device may use a network interface to communicate with a server application executing on a single server or on a cluster of servers that implement one or more of the components of the systems described herein in a cloud computing or non-cloud computing environment as implemented in various sub-systems. In another example, an instance of a server application executing on a computer system may use a network interface to communicate with other instances of an application that may be implemented on other computer systems.

The computing device also includes one or more persistent storage devices and/or one or more I/O devices. In various embodiments, the persistent storage devices may correspond to disk drives, tape drives, solid state memory, other mass storage devices, or any other persistent storage devices. The computer system (or a distributed application or operating system operating thereon) may store instructions and/or data in persistent storage devices, as desired, and may retrieve the stored instruction and/or data as needed. For example, in some embodiments, the computer system may implement one or more nodes of a control plane or control system, and persistent storage may include the SSDs attached to that server node. Multiple computer systems may share the same persistent storage devices or may share a pool of persistent storage devices, with the devices in the pool representing the same or different storage technologies.

The computer system includes one or more system memories that may store code/instructions and data accessible by the processor(s). The system memories may include multiple levels of memory and memory caches in a system designed to swap information in memories based on access speed, for example. The interleaving and swapping may extend to persistent storage in a virtual memory implementation. The technologies used to implement the memories may include, by way of example, static random-access memory (RAM), dynamic RAM, read-only memory (ROM), non-volatile memory, or flash-type memory. As with persistent storage, multiple computer systems may share the same system memories or may share a pool of system memories. System memory or memories may contain program instructions that are executable by the processor(s) to implement the routines described herein. In various embodiments, program instructions may be encoded in binary, Assembly language, any interpreted language such as Java, compiled languages such as C/C++, or in any combination thereof; the particular languages given here are only examples. In some embodiments, program instructions may implement multiple separate clients, server nodes, and/or other components.

In some implementations, program instructions may include instructions executable to implement an operating system (not shown), which may be any of various operating systems, such as UNIX, LINUX, Solaris™, MacOS™, or Microsoft Windows™. Any or all of program instructions may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to the computer system via the I/O interface. A non-transitory computer-readable storage medium may also include any volatile or non-volatile media such as RAM or ROM that may be included in some embodiments of the computer system as system memory or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via a network interface. A network interface may be used to interface with other devices, which may include other computer systems or any type of external electronic device. In general, system memory, persistent storage, and/or remote storage accessible on other devices through a network may store data blocks, replicas of data blocks, metadata associated with data blocks and/or their state, database configuration information, and/or any other information usable in implementing the routines described herein.

In certain implementations, the I/O interface may coordinate I/O traffic between processors, system memory, and any peripheral devices in the system, including through a network interface or other peripheral interfaces. In some embodiments, the I/O interface may perform any necessary protocol, timing or other data transformations to convert data signals from one component (e.g., system memory) into a format suitable for use by another component (e.g., processors). In some embodiments, the I/O interface may include support for devices attached through various types of peripheral buses, such as a variant of the Peripheral Component Interconnect (PCI) bus standard or the Universal Serial Bus (USB) standard, for example. Also, in some embodiments, some or all of the functionality of the I/O interface, such as an interface to system memory, may be incorporated directly into the processor(s).

A network interface may allow data to be exchanged between a computer system and other devices attached to a network, such as other computer systems (which may implement one or more storage system server nodes, primary nodes, read-only node nodes, and/or clients of the database systems described herein), for example. In addition, the I/O interface may allow communication between the computer system and various I/O devices and/or remote storage. Input/output devices may, in some embodiments, include one or more display terminals, keyboards, keypads, touchpads, scanning devices, voice or optical recognition devices, or any other devices suitable for entering or retrieving data by one or more computer systems. These may connect directly to a particular computer system or generally connect to multiple computer systems in a cloud computing environment, grid computing environment, or other system involving multiple computer systems. Multiple input/output devices may be present in communication with the computer system or may be distributed on various nodes of a distributed system that includes the computer system. The user interfaces described herein may be visible to a user using various types of display screens, which may include CRT displays, LCD displays, LED displays, and other display technologies. In some implementations, the inputs may be received through the displays using touchscreen technologies, and in other implementations the inputs may be received through a keyboard, mouse, touchpad, or other input technologies, or any combination of these technologies.

In some embodiments, similar input/output devices may be separate from the computer system and may interact with one or more nodes of a distributed system that includes the computer system through a wired or wireless connection, such as over a network interface. The network interface may commonly support one or more wireless networking protocols (e.g., Wi-Fi/IEEE 802.11, or another wireless networking standard). The network interface may support communication via any suitable wired or wireless general data networks, such as other types of Ethernet networks, for example. Additionally, the network interface may support communication via telecommunications/telephony networks such as analog voice networks or digital fiber communications networks, via storage area networks such as Fibre Channel SANs, or via any other suitable type of network and/or protocol.

Any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service’s interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP). In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and sub-combinations possible of the group are intended to be individually included in the disclosure. All references cited herein are hereby incorporated by reference to the extent that there is no inconsistency with the disclosure of this specification. When a range is used herein, all points within the range and all subranges within the range are intended to be included in the disclosure.

The present invention has been described with reference to certain preferred and alternative implementations that are intended to be exemplary only and not limiting to the full scope of the present invention.

1. A system for providing a user emergency access control to one or more segregated data sets in a cloud computing environment, the system comprising:
a unified data platform provided within the cloud computing environment, wherein the unified data platform comprises a number of cloud cores, wherein each of the cloud cores corresponds to one of the segregated data sets;
an access management engine storing authorization information for the user, wherein the authorization information identifies user access permissions;
a computer system implementing a compute management platform providing the user access to one or more cloud cores of the unified data platform based on the user access permissions for the user provided by the access management engine, wherein the compute management platform comprises executable instructions that when executed by the computer system facilitate the performance of operations comprising:
receiving from the user a request for access to one or more cloud cores of the unified data platform;
requesting from an approver approval of the request for access;
upon approval of the request for access, providing to the user temporary credentials and prompting the user to sign on using the temporary credentials;
once the user has signed on, providing the user access to one or more cloud cores based off the user access permissions associated with the user; and
at the expiration of a predetermined time period associated with the request for access, deleting the temporary credentials, thereby blocking the user’s access to the one or more cloud cores via the temporary credentials.
thereby providing the user emergency access only to the segregated data sets corresponding to the accessed cloud cores for the predetermined time period.

2. The system of claim 1, wherein the one or more segregated data sets comprise data sets segregated by at least one of client, at least one line of business, at least one geographical region, or at least one country.

3. The system of claim 1, wherein the one or more segregated data sets comprise data sets segregated by geographical region, and wherein each of the data sets are physically hosted in its corresponding geographic region.

4. The system of claim 1, wherein the user access permissions comprises permissions based on at least one client, at least one line of business, at least one geographical region, at least one country, or at least one data type.

5. The system of claim 1, further comprising one or more partner applications having authorized access to one or more of the cloud cores.

6. The system of claim 1, further comprising one or more shared resources synchronized across all cloud cores of the unified data platform.

7. The system of claim 1, further comprising a database in communication with the compute management platform, wherein the database is configured to store records associated with the request for access received from the user and the approval of the request for access by the approver.

8. The system of claim 1, further wherein the computer system facilitates the performance of the operation of providing a sub-account associated with one or more cloud cores and a master account associated with the unified data platform.

9. The system of claim 8, further wherein the computer system facilitates the performance of the operation of associating the temporary credentials with the master account, and once the user has signed on using the temporary credentials, switching the association of the credentials from associating with the master account to association with a sub-account.

10. A method for providing a user emergency access control to one or more segregated data sets in a cloud computing environment, the method comprising:
providing a unified data platform within the cloud computing environment, wherein the unified data platform comprises a number of cloud cores, wherein each of the cloud cores corresponds to one of the segregated data sets;
at an access management engine, storing authorization information for the user, wherein the authorization information identifies user access permissions; and
at a compute management platform:
receiving from the user a request for access to one or more cloud cores of the unified data platform;
requesting from an approved user approval of the request for access;
upon approval of the request for access, providing to the user temporary credentials and prompting the user to sign on using the temporary credentials;
once the user has signed on, providing the user access to one or more cloud cores based off the user access permissions associated with the user; and
at the expiration of a predetermined time period associated with the request for access, deleting the temporary credentials, thereby blocking the user’s access to the one or more cloud cores via the temporary credentials.
thereby providing the user emergency access only to the segregated data sets corresponding to the accessed cloud cores for the predetermined time period.

11. The method of claim 10, further comprising the step of registering and storing records associated with the request for access received from the user and the approval of the request for access by the approver in a database in communication with the compute management platform.

12. The method of claim 10, further including the step of, at the compute management platform, providing a sub-account associated with one or more cloud cores and a master account associated with the unified data platform.

13. The system of claim 12, further including the steps of, at the compute management platform, associating the temporary credentials with the master account, and once the user has signed on using the temporary credentials, switching the association of the credentials from associating with the master account to association with a sub-account.
